(19) United States
(12) Patent Application Publication
(10) Pub. No.: US 2016/0063413 A1
(43) Pub. Date: Mar. 3, 2016

(54) SOLAR ELECTRICAL SYSTEM OPTIMIZER

(71) Applicant: OneRoof Energy, Inc., San Diego, CA (US)

(72) Inventors: HUSSEIN YAHFOUFI, San Diego, CA (US); STEFAN MONTGOMERY, San Diego, CA (US); CHRIS KEAST, La Jolla, CA (US); FARAZ SHARAFI, San Diego, CA (US)

(73) Assignee: ONEROOF ENERGY, INC., San Diego, CA (US)

(21) Appl. No.: 14/472,333

(22) Filed: Aug. 28, 2014

(51) Int. Cl. G06Q 10/06; G06Q 50/16; H02S 99/00

(52) U.S. Cl. CPC G06Q 10/06313; H02S 99/00; G06Q 50/165

(57) ABSTRACT

Systems and methods are provided for optimizing a solar electric system to realize the highest net savings for a building owner. To optimize a solar electrical system, a number of roof planes associated with a building to be implemented with a photovoltaic (PV) system is determined. Depending on the number of roof planes, a type of PV system is determined on which to base an optimization determination. An iterative determination process is used to determine at least one PV kit combination for each PV product combination that produces the highest net savings for an owner of the building structure, the at least one PV kit combination making up the PV system, and each PV product combination including at least one PV module and at least one of a string inverter and a micro inverter.

### TECHNICAL FIELD

The present disclosure is generally related to solar power systems. In particular, the present disclosure is related to the optimization of solar electrical power kits.

### BACKGROUND

Solar power can refer to the conversion of sunlight into electricity using, e.g., photovoltaics (PV), which can refer to a method of electrical power generation through the conversion of solar radiation into direct current (DC) electricity using materials that exhibit the PV effect. That is, and when PV materials are exposed to radiation, such as sunlight, voltage and/or electrical current is created. PV systems are typically used in small to medium-sized applications, such as the powering of dwellings, buildings, etc., which can useful when accessing ‘grid’ power is inconvenient, expensive, or unavailable. More recently, reliance on solar power has been increasing even in applications where grid power is used, in an effort to feed low-carbon energy into the grid.

PV systems typically rely on a PV array/plurality of solar panels (also referred to as PV modules). Solar panels/PV modules can refer to a set of solar/PV cells, each containing a PV material such as monocrystalline silicon, polycrystalline silicon, amorphous silicon, etc. Also included in PV systems are one or more DC to alternating current (AC) power converters (also known as inverters), a racking system that supports the PV array, as well as various electrical wiring for interconnecting these PV system components. Still other components in a PV system may include, but are not limited to performance monitoring systems, energy consumption and production meters, a battery system and charger, sensors, solar tracking devices, etc.

### SUMMARY

In accordance with one embodiment, a method comprises determining a number of roof planes associated with a building structure to be implemented with a photovoltaic (PV) system. Additionally, the method comprises depending on the number of roof planes, determining a type of PV system on which to base an optimization determination. Further still, the method comprises iteratively determining at least one PV kit combination for each PV product combination that produces the highest net savings for an owner of the building structure, the at least one PV kit combination making up the PV system, and wherein each PV product combination comprises at least one PV module and at least one of a string inverter and a micro inverter.

In accordance with another embodiment, a solar electrical system optimizer comprises a memory configured to store instructions, and a processor, operatively coupled to the memory and configured to execute instructions. The instructions cause the processor to: initiate proposal generation, the proposal generation including one or more recommendations for a photovoltaic (PV) system optimized with regard to highest net savings for an owner of the building structure; determine a number of roof planes associated with a building structure to be implemented with the PV system; depending on the number of roof planes, determine a type of the PV system on which to base an optimization determination; and iteratively determine at least one PV kit combination for each PV product combination that produces the highest net savings for the owner of the building structure, the at least one PV kit combination making up the PV system, and wherein each PV product combination comprises at least one PV module and at least one of a string inverter and a micro inverter.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 illustrates an example PV system for which the technology described herein may be utilized to optimize in accordance with various embodiments.

FIG. 2 is a flow chart illustrating example processes performed in the context of generating solar electric system proposals for the optimization of a solar electric system in accordance with various embodiments.

FIG. 3 illustrates example data fields in a database format with linkages amongst database tables utilized in the optimization of a solar electric system in accordance with various embodiments.

FIG. 4 illustrates additional input data for the optimization of a solar electric system in accordance with various embodiments.

FIG. 5A is a flow chart illustrating example processes performed by an initial rules engine for determining a PV module type for the optimization of a solar electric system in accordance with various embodiments.

FIG. 5B is a flow chart illustrating example iteration rules for determining a PV kit combination for the optimization of a solar electric system in accordance with various embodiments.

FIG. 6 illustrates example output data for the optimization of a solar electric system in accordance with various embodiments.

FIG. 7A is a flow chart illustrating example processes performed to determine an optimal micro inverter PV kit size configuration for the optimization of a solar electric system in accordance with various embodiments.

FIG. 7B is an example iteration chart representative of the example processes of FIG. 7A.

FIG. 8A is a flow chart illustrating example processes performed to determine an optimal string inverter PV kit size configuration for the optimization of a solar electric system in accordance with various embodiments.

FIG. 8B is an example iteration chart representative of the example processes of FIG. 8A.

FIGS. 9A and 9B illustrate a representation of an example system architecture and overall process workflow for the optimization of a solar electric system in accordance with various embodiments.

FIG. 10 illustrates an example communications system architecture utilized for the optimization of a solar electric system in accordance with various embodiments.

FIG. 11 illustrates an example computing module that may be used to implement various features of embodiments described in the present disclosure.

The drawings are described in greater detail in the description and examples below.

### DETAILED DESCRIPTION

The details of some example embodiments of the methods and systems of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

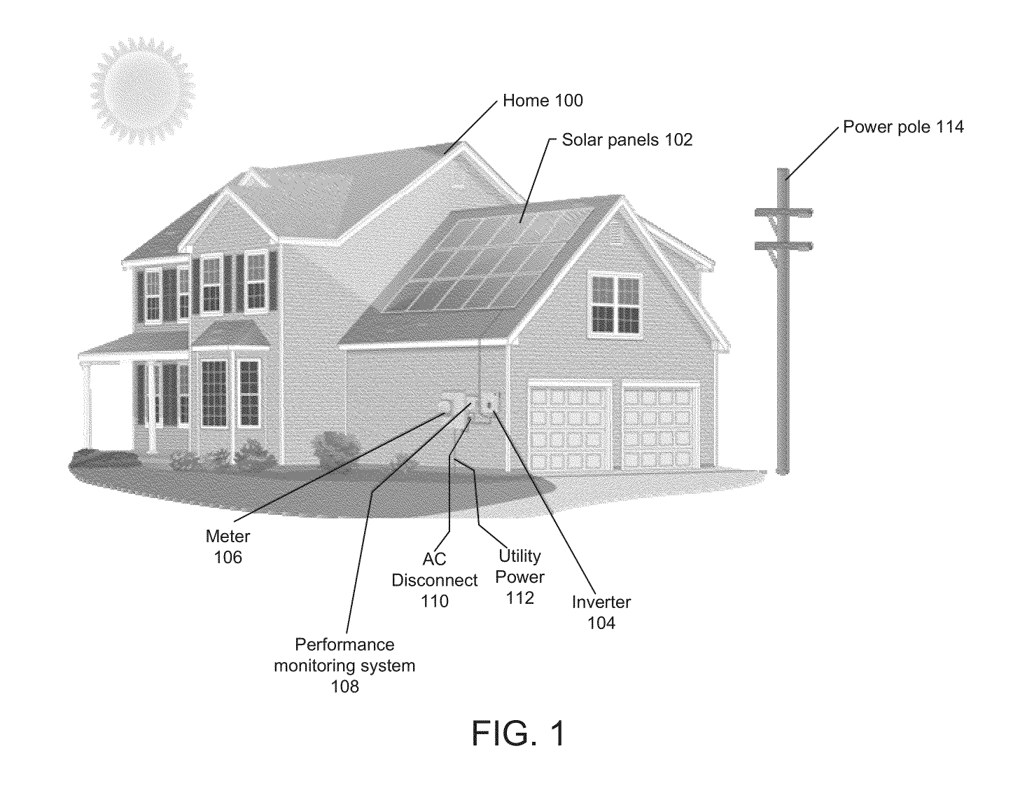

FIG. 1 illustrates an example PV system that may be utilized to, e.g., partially power or provide electricity to a home 100. As illustrated in FIG. 1, solar panels 102 may be mounted or otherwise located on the roof of home 100 or a portion thereof. As solar panels 102 are exposed to sunlight, each of the solar cells making up solar panels 102 convert the light into electric current. As would be understood by those of ordinary skill in the art, the solar cells produce DC power which can fluctuate with the sunlight's intensity. For practical usage, the DC power is converted to AC power, which can be performed by one or more inverters 104.

A meter 106, which may be a bi-directional meter, can be utilized to track the amount of electricity (e.g., in kWh) that is produced, consumed, and sent to the grid. The bi-directional aspect of meter 106 can indicate electricity consumption by spinning in one direction, and indicate an energy surplus by spinning in an opposite direction. This occurs when the electricity generated by solar panels 102 exceeds the power consumed by home 100, resulting in electricity that can be fed back into the grid. Feeding electricity back into the grid can result in the owner of home 100 receiving a monetary credit at a retail rate.

Performance monitoring system 108 can measure and monitor any and all energy that is generated by the PV system. Feedback can be provided to the owner of the home, for example, such as alerts regarding the performance of the PV system. Additionally, an AC disconnect 110 can be provided in the PV system for separating the electrical system of home 100 from the PV system if needed. AC disconnect 110 may be, e.g., some form of manual switching apparatus.

Utility power received via line 112 may still be utilized by home 100 to provide electricity from the grid (e.g., electricity generated at a power plant and transported, ultimately, via power pole 114). This can be done at night or during times of the day when the energy needs of home 100 exceeds that which can be provided/is stored in the PV system.

There are generally two types of inverters that can be utilized in a PV system. One such type of inverter can be referred to as a string inverter. A string inverter is an inverter that ties into the end of a ‘string’ or row of solar panels and converts the DC power generated by the solar cells into AC power. One or more strings of solar panels may be utilized in a single PV system. In the case of multiple strings of solar panels being used, the multiple strings are connected in parallel, with the resulting DC output being passed through a string inverter, which then feeds AC power to a main supply box. This AC power can be utilized and/or fed back into the grid, for which credit can be received by way of net metering.

Another type of inverter can be referred to as a micro inverter. Micro inverters, being smaller than the aforementioned string inverters, can be integrated into each individual solar panel. Accordingly, the conversion from DC to AC occurs at the solar panel. Each solar panel's AC supply may then be combined and fed into the main supply box.

The use of string inverters and micro inverters can involve certain considerations that may be taken into account with regards to, e.g., the desired efficiency, performance, etc. of a PV system. For example, when using string inverters, solar panel orientation should be consistent, i.e., the solar panels should face the same direction, even though optimal performance may require differing orientation of the solar panels. With a PV system based on micro inverters, each solar panel can be oriented in any manner to achieve optimal performance.

Another consideration may be that of shading. Shading can occur when trees, other buildings, obstructions such as snow, leaves, dirt, etc. shade or cover one or more solar panels or a portion thereof from receiving direct sunlight. Shading may adversely affect an entire string of solar panels in the event, e.g., one or two solar panels out of the string are shaded from the sunlight. Accordingly, use of a string inverter can lower performance by a significant amount. Conversely, micro inverters that are integrated into individual solar panels are less affected by shading as only those solar panels that are shaded result in reduced performance. That is, reduced performance can be isolated through the use of micro inverters.

Still other factors may include, but are not limited to the following. Future expansion of a PV system may be less costly through the use of micro inverters rather than string inverters. However, voltage drops are more problematic with AC versus DC. Accordingly, a micro inverter-based PV system may be susceptible to more power loss by transmitting converted AC power longer distances as opposed to a string inverter-based PV system that converts the DC to AC at the end of the string.

Given the above, in addition to factors such as the shape/makeup of a home's rooftop, the location of the home, etc., optimizing a PV system would be advantageous to realizing the most energy production, which in turn translates into the greatest cost savings. It should be noted that although various embodiments are herein described in the context of PV systems for residential dwellings/structures, the various embodiments can be adapted and/or utilized in other contexts, such as by considering other factors and making appropriate calculations instead of and/or in addition to those that will be discussed below.

Conventional methods for the optimization of a residential solar electric system and related financial information rely primarily on a ‘manual’ approach. That is, a solar electric system provider or leasing entity would rely on human personnel to map and measure each appropriate roof plane of a residential structure. Based on these measurements and mapping information, the personnel may perform manual calculations to decide what solar PV system size would be appropriate or optimal for the structure, as well as the total cost for the solar PV system, installation, etc. Thereafter, a solar financing proposal could be created for a particular property. Performing the abovementioned operations to arrive at a proposal would often require the use of myriad of software applications, including, for example, but not limited to Google Maps™, Microsoft® Word, Microsoft® Excel, various calculation software, among others. Moreover, the information needed when performing the abovementioned operations as well as presentation to a homeowner would be manually aggregated from disparate sources and into a centralized document, respectively.

Aside from the multitude of manual steps and manual data aggregation, conventional optimization requires various interactions between and amongst the multiple software applications, data sources/repositories, operating systems, and the like. Accordingly, solar financing proposals would be subject to frequent errors in data entry, information translation, and misinterpretation. Furthermore, this conventional approach to solar electric system optimization is often inefficient from an operational and economic perspective due to its laborious nature and quality control issues. It should be noted that while some attempts at improving solar electric system optimization have been made, such attempts may still require additional programming steps that prevent real-time optimization/proposal creation, and may still not achieve accurate results/recommendations.

Accordingly, various embodiments are directed to systems and methods for solar electric system optimization. Parameters/factors such as roof space, roof orientation, and electric utility input can all be considered in determining an optimum solar electric system, along with the corresponding savings that will be reflected in a homeowner's electricity bill. Moreover, these systems and methods can be implemented/performed in real-time for efficiency and increased customer satisfaction.

In particular, an optimization tool/utility, such as may be embodied in an application, can receive various types of input regarding, e.g., property and homeowner information, as will be described in greater detail below. The optimization utility may automatically generate the most size- and cost-effective solar electric system layout, design, and solar lease financing parameters for that property. It should be noted that while ‘optimum’ and most cost-effective configurations are sought be output by the application, such optimal configurations are subject to certain variability and/or subjectivity. Accordingly, various embodiments may be configured to provide optimal configurations and cost-effectiveness in the form of, e.g., a range of options or possibilities. Moreover, the terms optimum, optimal, optimized, etc. as utilized herein need not necessarily refer to an absolute best configuration, for example, but may refer to a preferred configuration.

The optimization utility can rely on input information that can be specified in/by certain input data fields. The optimization utility may perform multiple iterations of one or more processes and/or calculations in order to successively zero in on or near an optimal configuration of a PV kit(s) that can deliver optimal cost-effectiveness to a homeowner implementing the PV kit(s). The optimization utility may take into consideration, the following: the optimum total solar electric system size from all available combinations of PV kits that can fit onto each roof plane of an entire home (if multiple roof planes are present at the home); the total cost of procuring, installing, and interconnecting the solar electric system; and the resultant optimized net annual homeowner financial savings on their electricity bill. As utilized herein, the term ‘PV kit’ may refer to some combination of PV products, including at least solar panels/PV modules and an inverter(s) (i.e., micro inverter or string inverter), and may further include, but is not limited to an energy production tracking monitor, racking and other hardware, and flashing. One or more PV kits can be combined to create a total PV or solar electric system. For example, and for a structure having multiple roof planes, a PV kit may be associated with or cover each of the multiple roof planes, the total number of PV kits that cover all of the multiple roof planes making up the total PV or solar electric system.

As alluded to above, the optimization utility may receive various inputs in order to make determinations regarding optimal PV kit configurations. From a high-level perspective, these can include the following: (a) a property address and applicable zip code; (b) a homeowner's electric utility company, electric rate schedule, and projected inflation rate (in %); (c) the homeowner's current electricity consumption (in kWh) and/or electric bill (in $); (d) PV product and PV kit parameters, including, but not limited to, PV module wattages, inverter model, inverter efficiency, PV kit area (in ft²); (e) roof plane usable area (in ft²); (f) roof direction/azimuth (in degrees) relative to true north)(0°; (g) roof tilt (in degrees) relative to horizontal)(0°; (h) the solar access percentage (i.e., 100% minus shading percentage); and (i) financial parameters, including, but not limited to, total PV system cost (in $/W DC), financing rate of escalation, and other financing model parameters.

From a high-level perspective, the outputs generated by the optimization utility may include the following: (a) all available combinations of quantities of PV kits that fit on each roof plane, including, but not limited to, PV system size (in kW DC and kW AC), the number of modules on each roof plane, and a total number of modules for a project; and (b) for each PV system size combination, (i) the total project cost, including financing costs (in $); and (ii) the net annual electricity bill savings for the homeowner (in $). It should be noted that a project may be associated with a configuration for all the applicable roof planes of a structure in accordance with one embodiment. In accordance with another embodiment, a project may be associated with, e.g., a configuration for a single roof plane. This can be useful for scenarios where, e.g., a homeowner wishes to progressively implement a solar electric system one roof plane (or some portion of an entire roof) at a time.

As described above, the optimization utility can receive information regarding a residential property's location along with energy consumption patterns and thereafter, perform, e.g., multiple iterations of certain calculations to determine an optimum PV system that can be leased (or purchased) by the homeowner of the residential property and installed thereon, thereby providing the homeowner with the greatest amount of financial savings on their electricity bill.

In accordance with various embodiments, the optimization utility is contemplated to work in conjunction with or as a module within other software applications, such as a proposal generator than can be utilized by a PV kit leasing entity or provider, a homeowner, etc. to, e.g., configure a PV system, select financing, track installation, and monitor performance of the PV system. An example of such a software application is SunOpps, a web-based, end-to-end residential solar electric design and financing software platform offered by OneRoof® Energy that can be used by dealers, sales affiliates, direct sales people to design, sell, and manage residential solar electric systems.

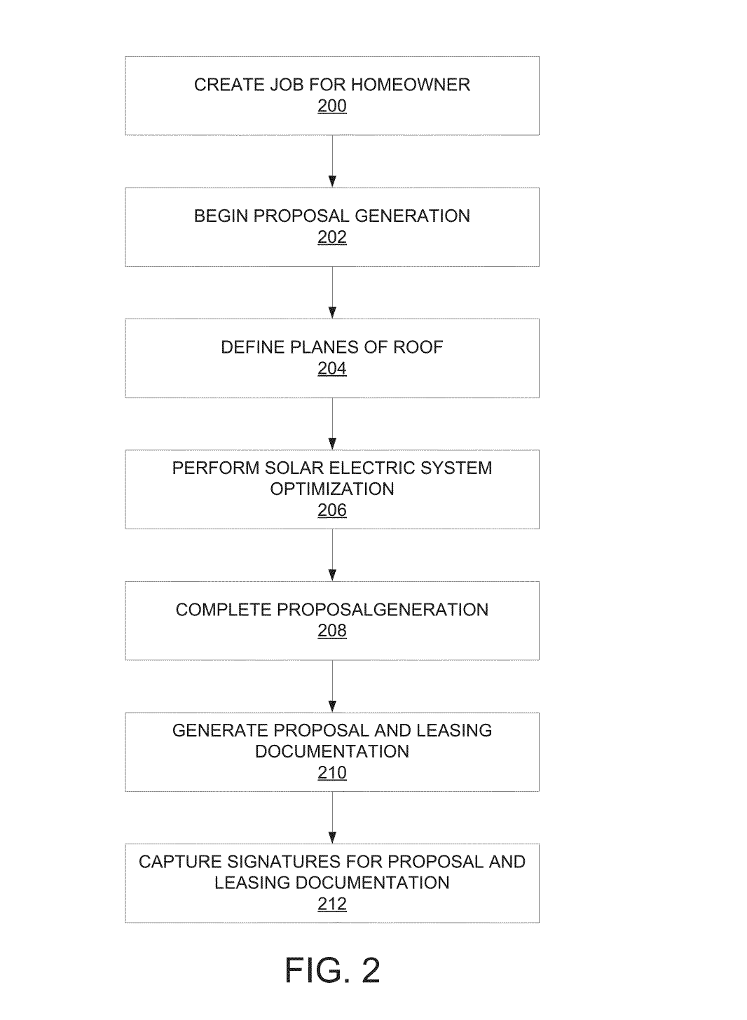

FIG. 2 is a flow chart illustrating example processes performed in the context of generating solar electric system proposals in accordance with various embodiments. At operation 200, a job or proposal instance may be created for a particular homeowner of a residential property. At operation 202, proposal generation can be started by the entry of various information, as described above. One such type of information that is entered includes that which characterizes the roof of the residential property. Accordingly, at operation 204, the planes of a roof may be defined. At operation 206, the optimization utility can be initiated to perform solar electric system optimization, thereby providing optimum PV kit(s) recommendations. At operation 208, proposal generation can be completed. At operation 210, a physical or otherwise presentable copy/copies of the generated proposal and any applicable leasing/purchase documentation can be output. At operation 212, the appropriate signature(s) (e.g., that of the homeowner(s)), can be captured for the proposal and/or leasing/purchase documents. For example, the appropriate signature(s) may be electronic signatures.

Determining an optimal PV kit can involve one or more calculations that can be performed based upon an area of a roof that can accommodate solar panels. That is, the optimization utility can be configured to automatically determine an optimal PV kit(s) that can fit into that roof area to produce the most savings for a homeowner. In particular, and in accordance with one embodiment, the optimization utility may rely on one or more rules engines and algorithms to ascertain the largest PV kit that can be installed given the area of a roof.

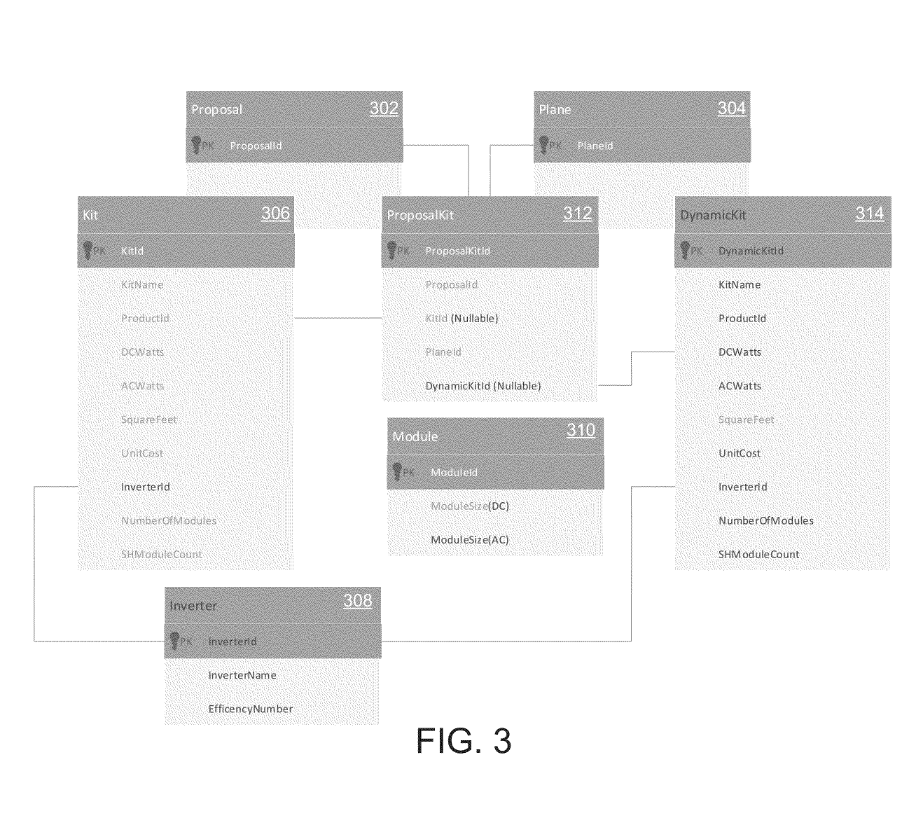

Accordingly, a plurality of data fields can be defined to allow for the passage of data/information to the optimization utility. In accordance with one embodiment, such data fields are described below, in a database format with linkages amongst database tables as illustrated in FIG. 3. FIG. 3 illustrates a ‘Proposal’ data field 302 which can include proposal identifiers, which may be unique textual and/or numerical values that can be associated with a particular proposal/job. As described above, the optimization utility can base its recommendations relative to one or more planes of a roof, which can be identified in ‘Plane’ data field 304 that includes one or more plane IDs corresponding with the defined planes of a roof.

As also described above, PV kits can be proposed as an optimal PV kit recommendation(s) in a proposal, where the PV kits can be defined in a ‘Kit’ data field 306. Kit data field 306 may include, but is not limited to the following data: a Kit ID, a Kit name, a product ID, the associated DC and AC capabilities (e.g., in W) of a particular Kit, the square footage that can be accommodated by a particular PV kit, the associated cost of any hardware, modules, installation, etc., an inverter ID associated with the PV kit, the number of solar panels/modules that are used in a PV kit, and a safe-harbor module (SHM) module count (used in cases when safe harbor equipment is used in PV product offerings that allow for capital investment interests to obtain United States Federal “Investor Tax Credits (ITC)” for a portion of the projects initial monetary cost). The inverter itself can be defined in an ‘Inverter’ data field 308, which may include the aforementioned inverter ID, the name of the particular inverter, and an efficiency number associated with the particular inverter. Further still, solar modules can be defined in ‘Module’ data field 310, data associated with each defined module can include the size of the module in terms of, e.g., both AC and DC capacity. Proposal kits can be defined in a ‘Proposal kit’ data field 312, which can defined based on the appropriate kit and plane data, which can be obtained via the appropriate data fields, and linked to or otherwise associated with the appropriate proposal/job.

It should be noted that a ‘Dynamic Kit’ data field 314 can be utilized in accordance with various embodiments to define a ‘new’ PV kit on-the-fly, as opposed to, e.g., utilizing existing/known PV kits, which may be used in a particular proposal. For example, a user of the optimization tool may see a need for a PV kit, the configuration of which may differ from known/default configurations. Accordingly, a new PV kit can be defined using the same parameters as those discussed above with regard to the definition of a kit in Kit data field 306.

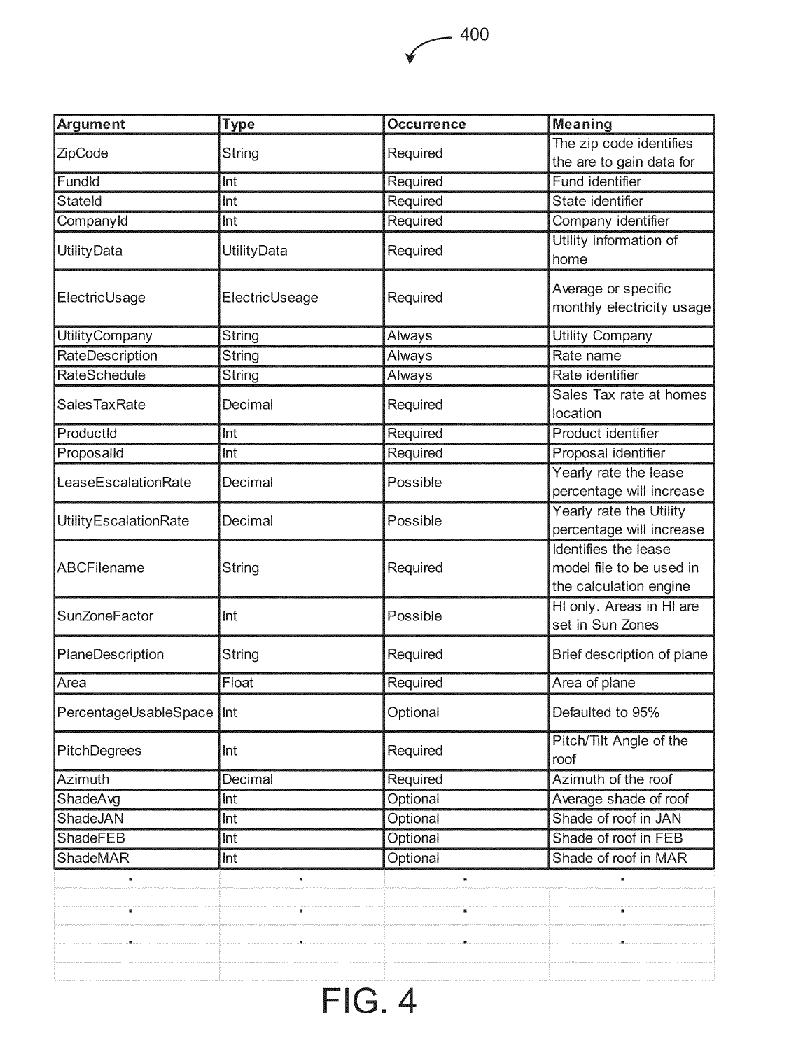

Still other data that may be used as input for the optimization utility are illustrated in FIG. 4 as table 400 in web service format. This data can be used by the optimization tool to refine the determinations made regarding optimal PV kit configurations, as well as provide, e.g., cost-savings information that is as accurate as possible. For example, such data can include: the relevant zip code; fund, state, and company identifiers; home utility information; electrical usage data; the relevant utility company, rate description, rate schedule, and applicable sales tax rates; product and proposal identifiers (as previously discussed); optional lease and utility escalation rates; third party data regarding the appropriate lease model to be utilized in determining, e.g., a total solar electric system cost; whether a property is within a ‘sun zone’ and how much ‘sun’ the property may experience; a description of the roof planes, area, and percentage of useable space on the roof(s); pitch and azimuth information; as well as monthly shading data.

It should be appreciated that not all of the data listed in FIG. 4 is necessarily needed by the optimization utility. For example, it may be that the cost of a total PV system can be satisfactorily determined without knowledge of or without disclosing a utility escalation rate and/or lease escalation rate. Moreover, while certain data is reflected as being required or always occurring, again, such data can be adjusted and/or deemed optional in accordance with certain embodiments. For example, the optimization utility can be configured to provide more generalized PV kit recommendations for a ‘theoretical’ residential dwelling or that can be generally applicable to a plurality of home models rather than a particular one. Accordingly, for example, plane description alone may be sufficient for calculating PV kit recommendations.

A rules engine can be used by the optimization utility to determine what grouping of PV products should/can be used based on the aforementioned factors and parameters input to the optimization utility. It should be noted that the rules engine can be configured to be as simple or as complex as may be required or desired to handle the number of different PV products and configurations that may be available or appropriate for a particular property or job at any given time.

For example, and considering a particular structure, if any of the roof planes of the structure are set to a direction/face north of the east-west horizontal axis, such roof planes may be disregarded for purposes of calculating an optimal PV kit(s) configuration. That is, it might be deemed that installing solar panels on a north-facing direction would be sub-optimal (as opposed to facing in a southerly direction which would be optimal) in the case of structures located in the northern hemisphere of the earth. Accordingly, roof planes that would not allow for south-facing solar panel installation, would not be considered. As another example, if a particular structure has a roof that has been defined with more than a single plane or there is more than one roof, the use of a micro inverter may be preferred and used as a default PV product. Otherwise, a string inverter may be used as the default preferred inverter type.

Subsequent to the rules engine determining whether the configuration of PV product(s) is, e.g., string inverter-based or micro inverter-based, the optimization utility may determine a minimum and maximum number of PV kit(s) that can be utilized with the particular structure. Further still, the optimization utility may then analyze each possible PV kit combination/configuration. That is, an initial number of PV kits that is some percentage of the maximum number of PV kits/total solar electric system may be analyzed to determine forecasted solar electric system energy production as well as total solar electric system project cost values for each defined PV kit. For example, the optimization utility may calculate two to eight initial total PV system sizes (typically five PV system sizes, depending on how many PV systems are available between the minimum and maximum PV system size) and determine a breakdown of the homeowner electricity bill savings from the energy produced by each total PV system and the total PV system project cost of the PV system installed for each PV system size. The optimization utility may then determine the best homeowner savings through this algorithm.

As should be understood, the above-described algorithm/process of analyzing PV systems can be adapted for use with multiple roofs/roof planes structures. For example, the optimization tool can determine projected PV system energy production and cost by comparing single string inverter PV kits and multiple plane/roof configurations based on micro inverter-type PV products.

The optimization utility can be configured to access data from third party providers to assist in determining the electricity rates and energy consumption values before and after a solar electric system is installed, forecasted solar electric system energy production, and financial parameters of each solar electric systems' configuration used in the aforementioned algorithm. To realize this functionality, web services are developed as part of the aforementioned software application or as part of the optimization utility itself that allow for making calls, e.g., externally to third party application programming interfaces (APIs) to access such data.

In accordance with one embodiment, a series of web services referred to as ‘CPEFunctions’ may be offered by one such third party provider that can calculate and return data specified in commensurate data fields. Such data can include, but is not limited to the following: monthly electric bill for a property without solar power/capabilities (‘EBillWithoutSolar’); monthly electric bill with solar power/capabilities (‘EBillWithSolar’); the amount of electricity bought, e.g., yearly, from a utility provider (‘AnnualBoughtFromUtility’); an estimate of the amount of energy produced in a first year including any excess power generation greater than a home's current consumption amount (‘TotalYearOneEstimatedProduction’); an estimate of the amount of power generated by a PV system per year (‘EstimatedAnnualProduction’); the amount of energy purchased excluding energy produced via solar power (‘YearLoadPurchased’); the amount of energy produced by the PV system (‘YearLoadProduced’); the amount of excess energy produced by the PV system that exceeds (>100%) the amount of energy purchased, i.e., YearLoadPurchased (‘YearLoadExcess’); any incentive amount from a utility provider (‘Solar Rebate Amount’); and any Federal Tax Credit amount (‘TaxCredit’).

Another web service, that can be referred to as ‘ABCFunctions’ may be offered by another third party provider that can calculate and return the following data specified in commensurate data fields: an initial down payment (‘DownPayment’) for a PV system; and lease payments for the year for the PV system (‘LeasePayment’).

As described previously, certain rules may be programmed into a rules engine for determining a PV product configuration, i.e., string inverter or micro inverter-based PV kit. These ‘initial’ rules can be used to make certain calculations to determine the optimal type of inverter to utilize depending on factors such as the number of roof planes existing on a structure, as well as shading.

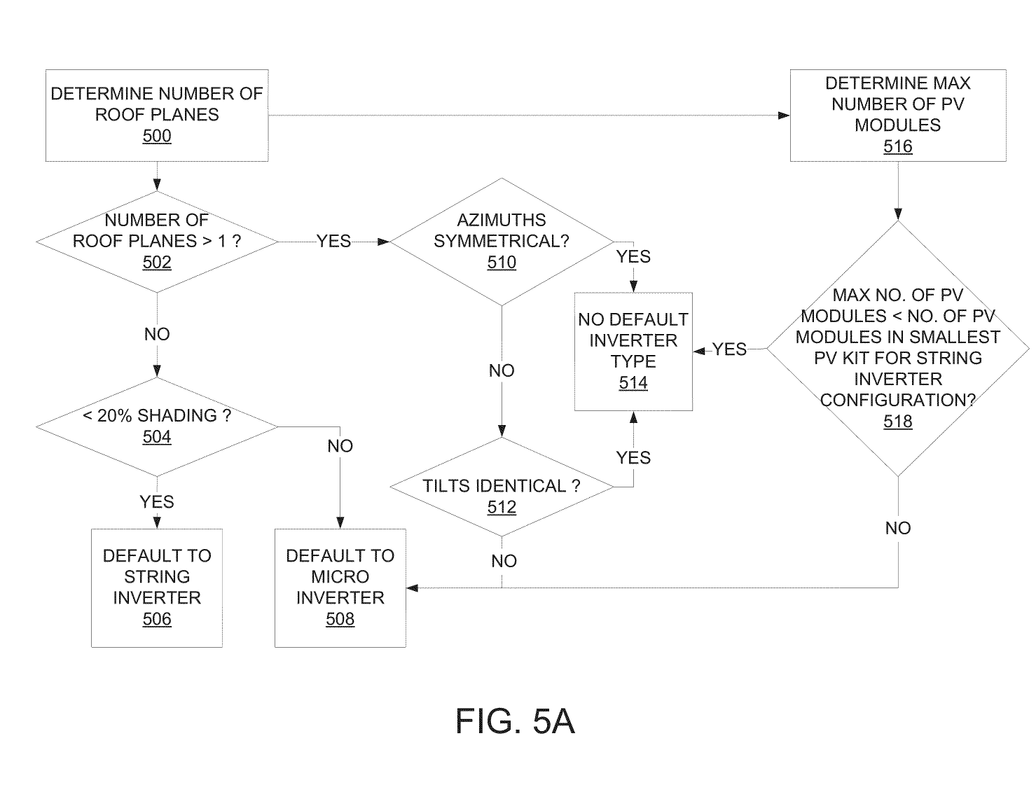

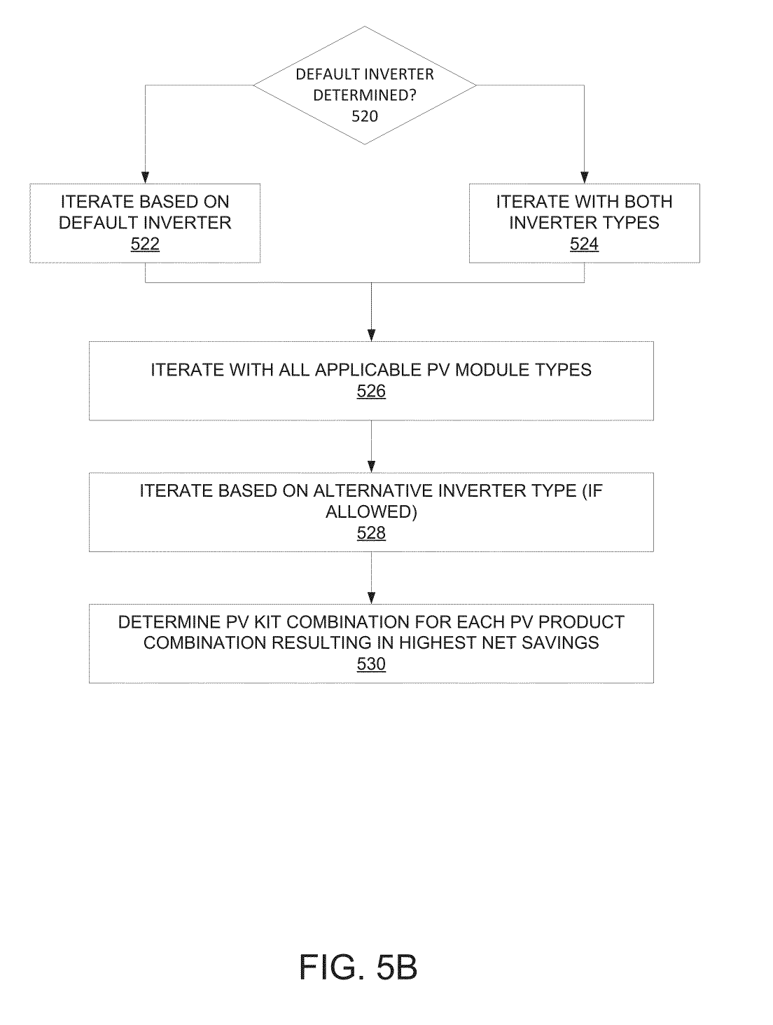

FIG. 5A illustrates these initial rules in accordance with one embodiment in a flow chart format. At 500, the number of roof planes of a property/structure is determined. At 502, it is determined whether the number of roof planes is greater than one. If the number of roof planes is not greater than one, it is determined at 504 whether the percentage of shading on the roof plane is less than 20%. If the percentage of shading on the roof plane is less than 20%, the default PV product type to be used in subsequent calculations (as will be discussed in greater detail) is set to a string inverter type at 506. If the percentage of shading is greater than 20%, a micro inverter-based PV product configuration becomes the default at 508.

If at 502, it is determined that the number of roof planes exceeds one, i.e., multiple roof planes exist on the property/structure, it is determined whether or not the azimuths (i.e., the respective directions of each of the roof planes) are symmetrical at 510. If the azimuths are determined to be non-symmetrical, it is determined whether or not the respective tilts of the roof planes are identical at 512. If the roof plane azimuths are symmetrical, no default PV product configuration with regard to inverter type is set at 514. The same is true if the roof plane tilts are identical (or substantially similar).

As utilized herein, the term azimuth may refer to a solar panel's east-west orientation resulting from its placement on a roof plane. For example, an azimuth of zero would refer to a roof plane facing the equator. Tilt as utilized herein, can refer to the angle of a roof plane (which in turn may affect the tilt of a solar panel installed thereon) relative to the ground/horizontal plane. Because the sun is higher in the summer and lower in the winter for a particular locale, tilt of a roof plane can affect the amount of solar energy that can be captured.

At 516, the maximum number of PV modules on a roof plane is determined. At 518, it is determined whether the projected maximum number of PV modules on a roof plane is less than the number of PV modules in a smallest possible PV kit based on a string inverter-type PV product. If not, the initial rules default to a micro inverter-type PV product. If so, again, no default inverter type is set.

As alluded to previously, the optimization utility may perform multiple iterations of one or more processes and/or calculations in order to successively zero in on or near an optimal configuration of a PV kit(s) that can deliver optimal cost-effectiveness to a homeowner. Accordingly, the optimization utility may utilize one or more ‘iteration’ rules as part of its calculations for determining an optimal solar electric system design.

FIG. 5B illustrates these iteration rules in accordance with one embodiment in a flow chart format. At 520, it is determined whether or not a default inverter type/PV product configuration has been decided on. This decision can be made via the initial rules described above. If the initial rules have determined that a default inverter is to be used, whether a micro inverter or string inverter PV product configuration, iteration is based on that default inverter type at 522. If no default inverter type has been determined, e.g., the roof planes of a structure are symmetrical and/or the roof plane tilts are the same, or if the projected maximum number of PV modules on a roof plane is less that the number of PV modules in a smallest possible string inverter-based PV kit, iterations are performed with both inverter types at 524. At 526, iterations can be performed with all the applicable PV module types in conjunction with all the applicable inverter types using a ‘goal-seeking’ process which will be described in greater detail below. At 528, if allowed (e.g., if the projected maximum number of PV modules on a roof plane is less that the number of PV modules in a smallest possible string inverter-based PV kit) further iterations can be performed based on the alternative inverter type. At 530, a PV kit combination is determined for each PV product combination that produces the highest homeowner net savings. That is, for every module-inverter product offering, the module-inverter kit within that product offering that provides the highest homeowner savings is generated can be referred to as an optimum PV kit.

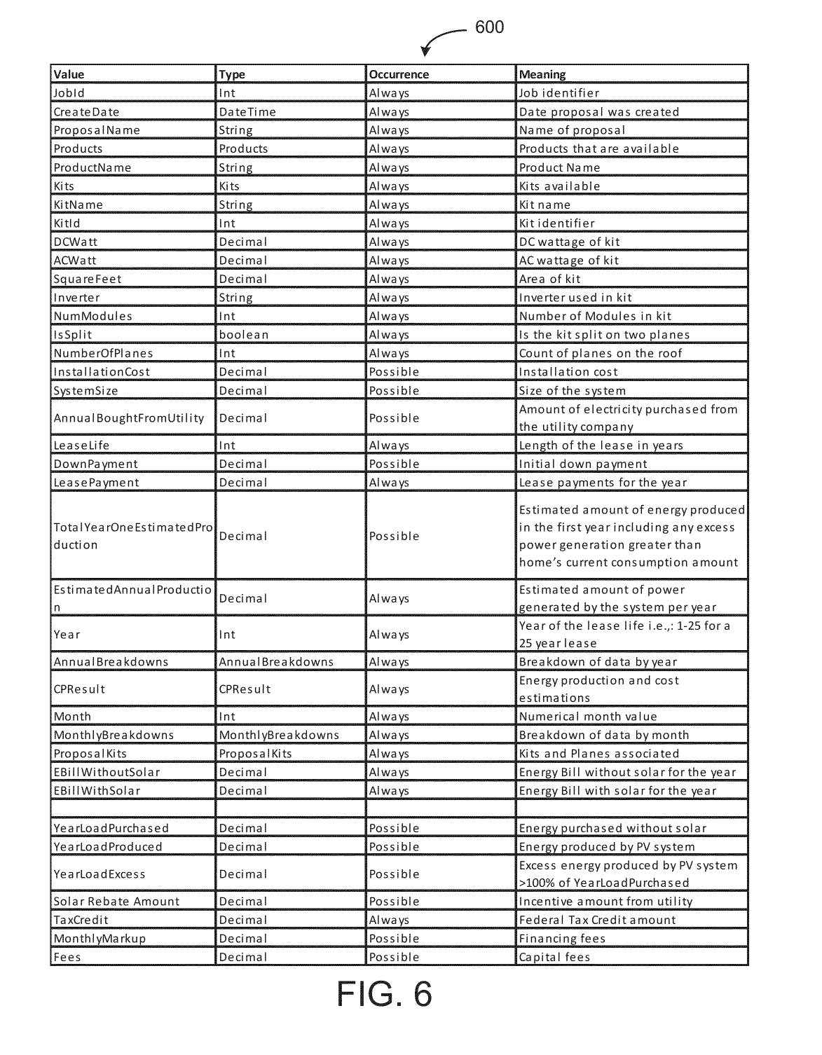

As previously discussed, the optimization utility can output, at a high level, information regarding all the available combinations of PV kits for each roof plane of a structure, total project cost, and net annual electricity bill savings. FIG. 6 illustrates a table 600 indicative of the detailed output data fields (and data contained therein) in a web service format which can be optimized by the iterative processes alluded to above and described in greater detail below. As with the inputs discussed above, and illustrated in table 400, some of the output data fields may be optional depending on the level of detail or granularity with which the output information is to be presented/determined. Some of the data/data fields may be accessed via third party providers, e.g., CPEFunctions and ABCFunctions as described above, while other data/data fields may be specified internally within/by the optimization tool/software application described previously, such as those discussed with respect to FIG. 3.

As previously indicated, iterations can be performed with all the applicable PV module types in conjunction with all the applicable inverter types using a goal-seeking process. This goal-seeking process can provide projected highest savings PV configurations for micro inverter and string inverter based PV products.

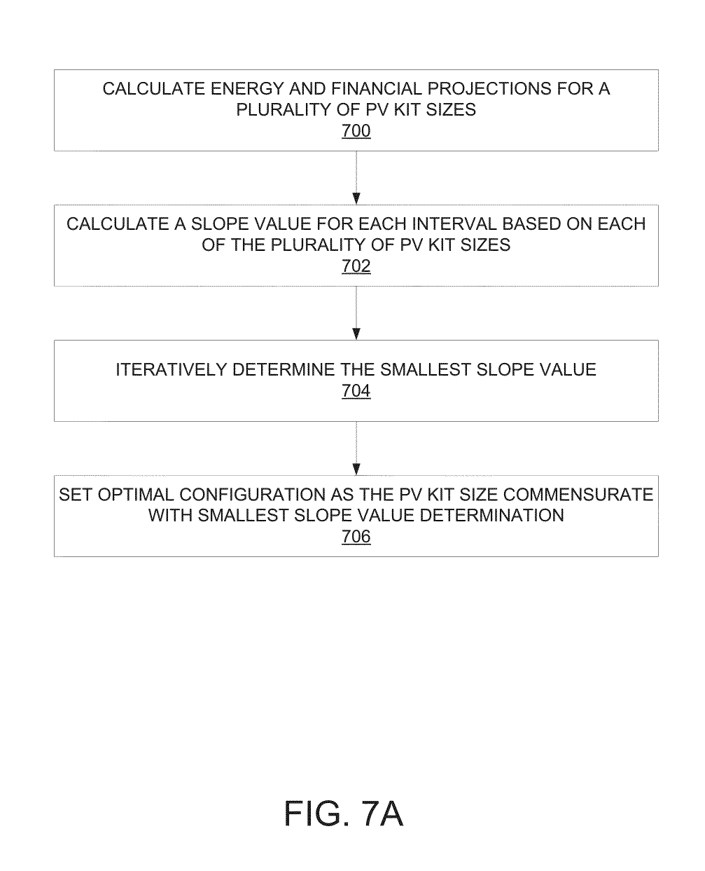

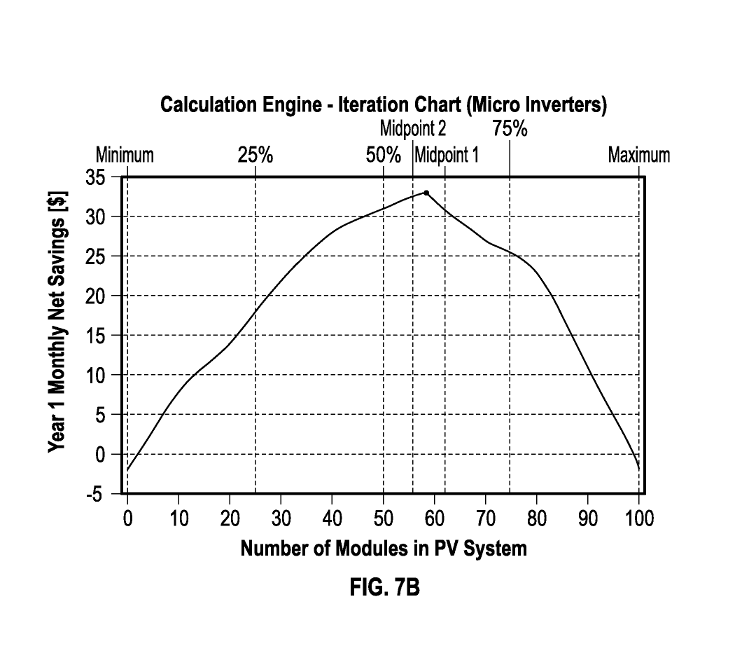

FIG. 7A is a flow chart illustrating example processes performed for calculating projected highest savings PV configurations based on micro inverter-based PV products in accordance with one embodiment. At operation 700, energy and financial projections/forecasts for a plurality of PV kit sizes is calculated. As described above, these calculations may be performed, in part, by running sets of calls to third party vendors, i.e., the CPEFunctions and ABCFunctions. For example, the energy and financial projections can be calculated for a determined minimum number of PV modules, a maximum number of PV modules, and at additional points reflective of, e.g., 25%, 50%, and 75% of the maximum number of PV modules. It should be noted that the points as well as the number of points considered between the minimum and maximum number of possible PV modules can be varied. At operation 702, a slope value is calculated for each interval based on each of the plurality of PV kit sizes.

That is, ‘intervals’ may be defined as areas between the aforementioned points reflective of PV kit size, i.e., monthly net savings as a function of PV kit size (the number of PV modules). The ‘slope value’ can be considered to be a ratio of the delta/change in monthly net savings as a function of PV kit size (the number of PV modules), and can be an absolute value defined as follows:

slope=ABS[(y₂−y₁)/(x₂−x₁)]

Referring to FIG. 7B, an example iteration chart indicative of monthly net savings during a first year as a function of total PV kit size (number of PV modules), values y₁ and y₂ may be indicative of points along the y-axis pertaining to a first year of monthly net savings (e.g., annual net savings over the first year of utilizing a PV system/12 months). Values x₁ and x₂ may be corresponding points on the x-axis indicative of total PV kit size (number of PV modules) in kW DC. The annual net savings can be defined as follows:

Yr 1 Monthly Net Savings=(EBillWithoutSolar[$]−(EBillWithSolar[$]+Lease Pay[$]))/12 months

In the example presented in FIG. 7B, a first determined smallest slope occurs in the interval between 50% of the maximum number of PV modules and 75% of the maximum number of PV modules. The midpoint between these two points is just over 60% of the maximum number of PV modules. The second determined smallest slope occurs between the lower of the first point (i.e., 50% of the maximum number of PV modules) and the first midpoint. A second midpoint may then be determined to be at approximately 55% of the maximum number of PV modules.

Referring back to FIG. 7A, the smallest slope value is iteratively determined at operation 704, i.e., various calculations may be performed to progressively narrow down PV kit size possibilities/options to an optimal configuration. That is, and subsequent to determining the slope value for each interval, the two points having the smallest slope value therebetween is identified. The midpoint between the two identified points having the smallest slope value is identified, and an additional call to the CPEFunctions and ABCFunctions is performed to determine the corresponding energy and financial projections for the PV kit size corresponding to that identified midpoint. As a result of identifying this midpoint, two additional intervals are defined, the two intervals occurring between the lesser of the first two points determined to have the smallest slope value therebetween and the midpoint, and between the midpoint and the greater of the first two points determined to have the smallest slope value therebetween. Slope values corresponding to the two additional intervals may be determined. Thereafter, a new smallest slope value can be determined. In general, the gains in net monthly savings will tend to peak between at some range of PV kit sizes as the number of projected PV kit sizes increases and then begin to drop off again. Hence, the aforementioned smallest slope value determination can be iteratively repeated to narrow in/focus on the optimal PV kit size identifying increasingly smaller intervals having the smallest scope value therebetween, i.e., that interval or midpoint in the interval that experiences the smallest delta/change in projected net monthly savings. It should be noted that the number of iterative determinations that may be performed can be variable. At operation 706, the optimal configuration is set as the PV kit size commensurate with the smallest slope value determination.

It should be noted that when multiple PV module options are offered (where PV module option can refer to, e.g., a particular brand, model type, etc. of solar panels), the aforementioned smallest slope determination can be repeated for each product offering to iterate and find the optimum PV module count among all the offerings. For example, PV module offering A may utilize PV module X while PV module offering B utilizes PV module Y. The iterative steps can be performed/repeated as to each offering and the optimum value among these two product offerings can be deemed the optimum PV module count. As alluded to previously, the aforementioned goal-seeking process for highest savings PV configuration can be iteratively repeated for the alternate PV type (in this example, string inverter-based PV modules).

Additionally, any and all relevant data (as described above) resulting from the performance of the goal-seeking process can be displayed to a user via graphical user interface (GUI). This GUI can be presented on a computer workstation, tablet computer, mobile device, etc. The GUI may present the relevant data in textual, numerical, graphical/visual, auditory, and/or any other applicable format appropriate for delivery to the user.

FIG. 7B is a flow chart illustrating example processes performed for calculating projected highest savings PV configurations based on string inverter-based PV products in accordance with one embodiment. Similar to FIG. 7A, at operation 800, energy and financial projections/forecasts for a plurality of PV kit sizes is calculated. As described above, these calculations may be performed, in part, by running sets of calls to third party vendors, i.e., the CPEFunctions and ABCFunctions. In this instance, and due to the projections being based on string-inverter PV modules, the energy and financial projections can be calculated for a determined minimum and maximum number of PV modules that can be based on the number of allowable ‘stringable’ inverters/PV modules. Additional points reflective of, e.g. the sizes of PV kits closest to 25%, 50%, and 75% of the maximum number of PV modules are also determined. Again, the points as well as the number of points considered between the minimum and maximum number of possible PV modules can be varied. At operation 802, a slope value is calculated for each interval based on each of the plurality of PV kit sizes.

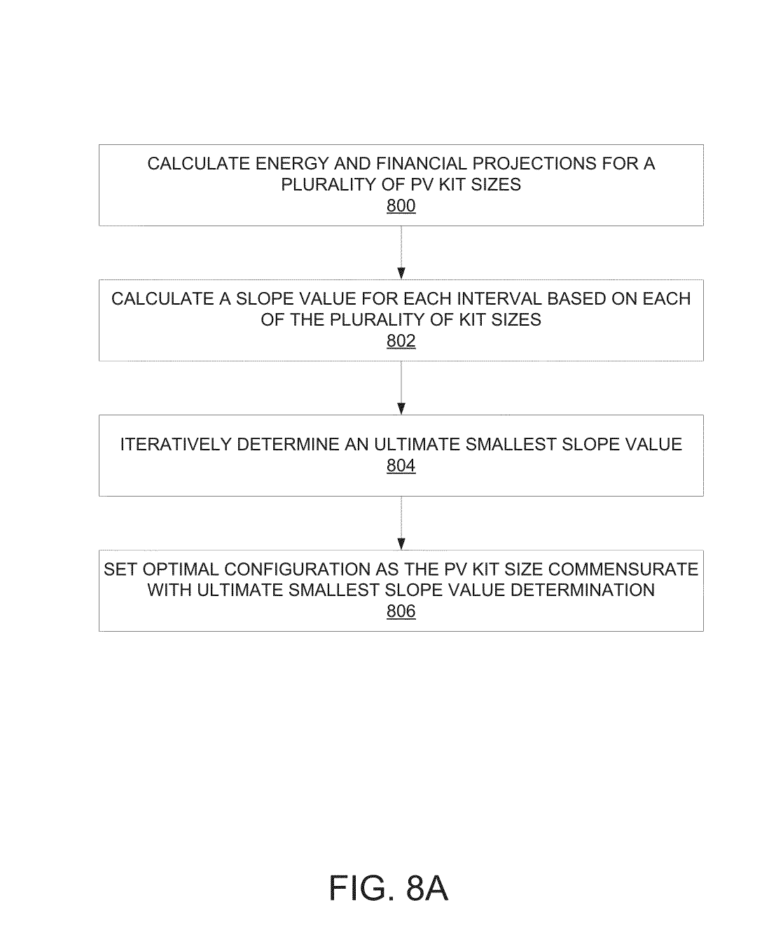

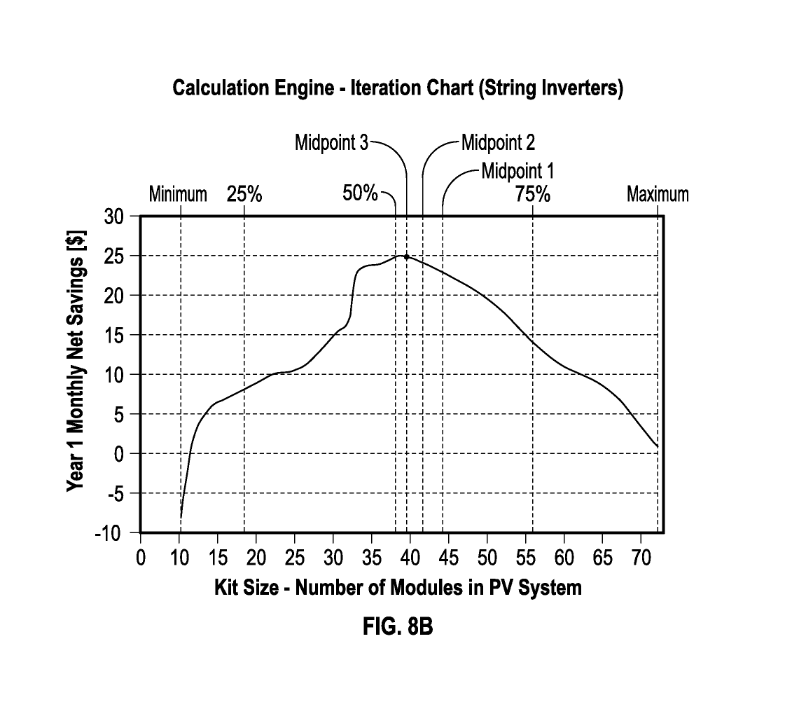

The smallest slope value is iteratively determined at operation 804. Referring to FIG. 8B, a first determined smallest slope occurs in the interval between the closest PV kit size to 50% of the maximum number of PV modules and the closest PV kit size to 75% of the maximum number of PV modules. The midpoint between these two points is approximately just under the closest PV kit size to 45% of the maximum number of PV modules. The second determined smallest slope occurs between the lower of the first point and the first midpoint. A second midpoint may then be determined to be at approximately at the closest PV kit size to 42.5% of the maximum number of PV modules. Another midpoint may be determined at approximately just under the closest PV kit size to 40% of the maximum number of PV modules.

Subsequent to the determination of the additional midpoints, additional calls to the CPEFunctions and ABCFunctions may be performed to determine the corresponding energy and financial projections for the PV kit size corresponding to that identified midpoint. Again, the aforementioned smallest slope value determination can be iteratively repeated to narrow in/focus on the optimal PV kit size identifying increasingly smaller intervals having the smallest scope value therebetween, i.e., that interval or midpoint in the interval that experiences the smallest delta/change in projected net monthly savings. It should be noted that the number of iterative determinations that may be performed can be variable. At operation 806, the optimal configuration is set as the PV kit size commensurate with the smallest slope value determination. The aforementioned goal-seeking process for highest savings PV configuration can be iteratively repeated for the alternate PV type (in this example, micro inverter-based PV modules. Additionally, any and all relevant data (as described above) resulting from the performance of the goal-seeking process can be displayed to a user via a GUI.

From the outputs (e.g., data parameters/relevant data) determined by the optimization utility, a user can decide whether to proceed with the calculated optimum solar electric system or to reiterate by changing any of the input data fields listed and re-running the aforementioned operations/processes/algorithms.

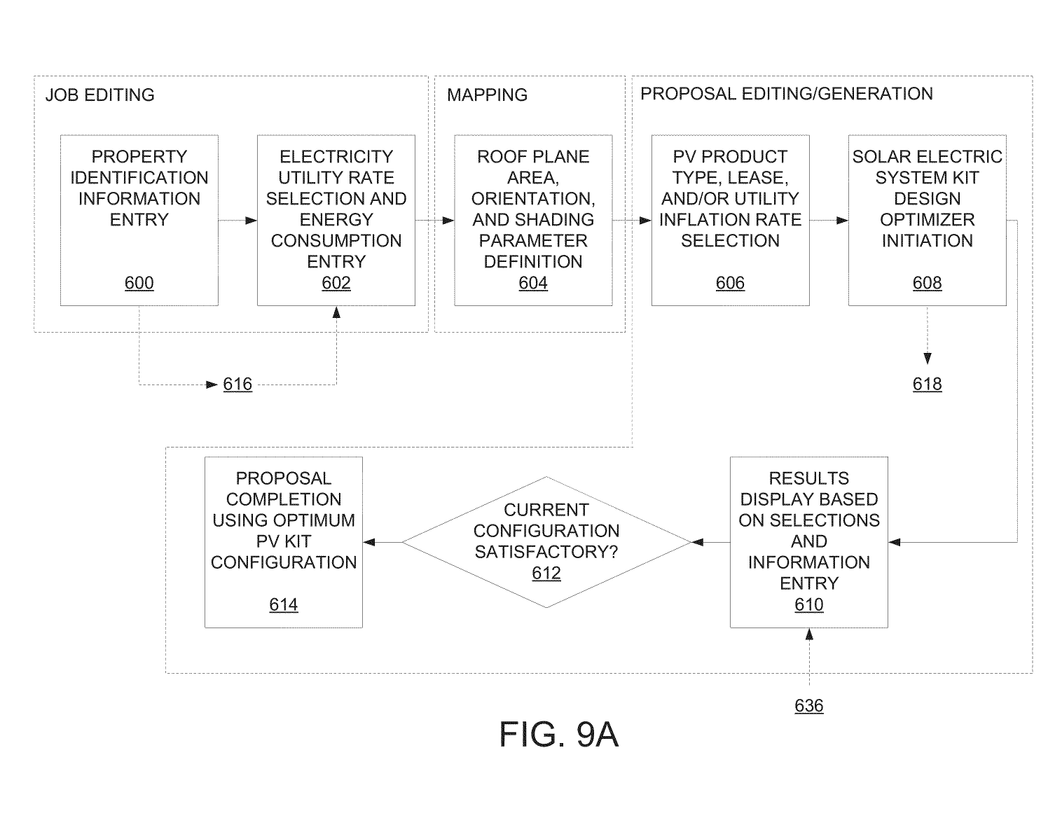

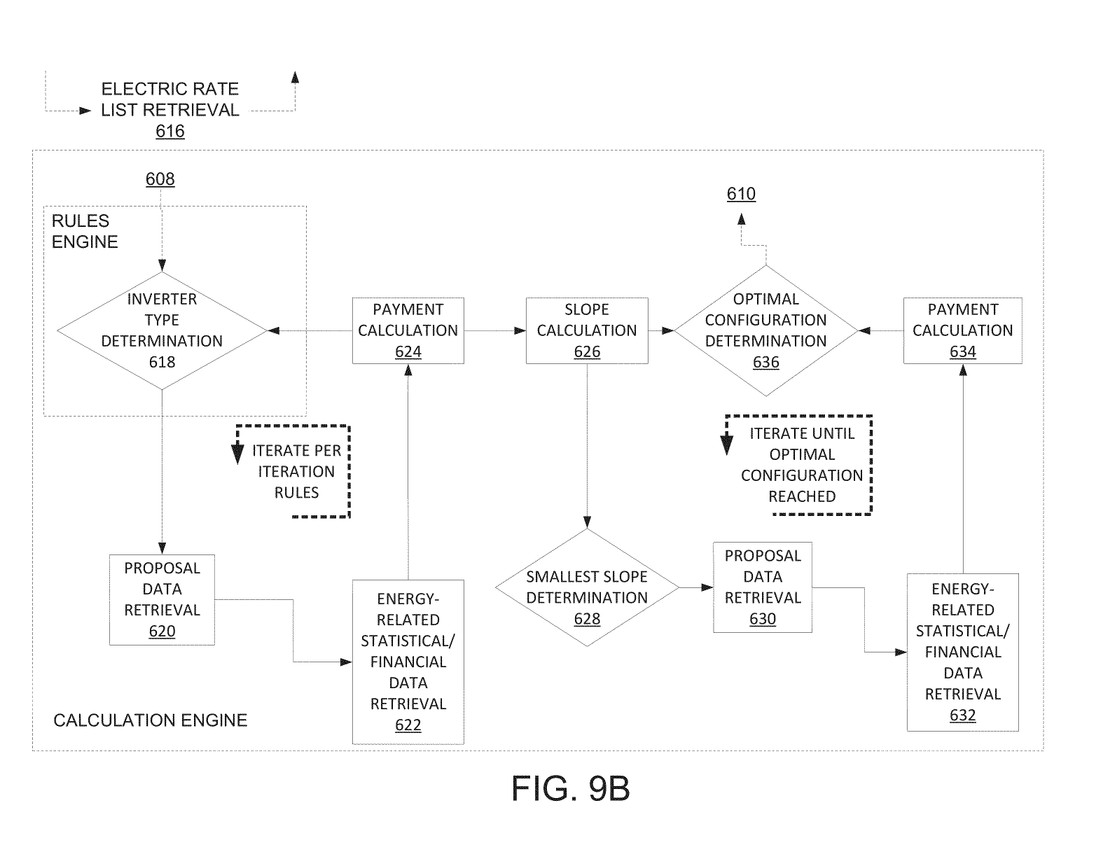

FIGS. 9A and 9B illustrate a representation of an example system architecture and overall process workflow for optimizing a solar electric system in accordance with various embodiments as it pertains to the following: the above-mentioned GUI; optimization application(s); and various internal/local and/or third-party services layers, including an initial rules engine an iteration rules engine, a goal-seeking process for highest savings PV configuration determination, peripheral data capture utilities, and web services used to send and return data between these architectural layers.

Referring to FIG. 9A, job editing, mapping, and proposal editing/generation modules are illustrated. These modules may be implemented as part of a GUI that a user may utilize to enter relevant data to allow the optimization utility to perform the aforementioned processes. The job editing module may include a property identification information entry module for accepting input data relevant to the identification of a property at issue as well as an electricity utility rate selection and energy consumption entry module 602. A mapping module may include a roof plane area orientation and shading parameter definition module configured to accept the aforementioned data that can be used to describe the relevant roof and potential shading characteristics of a roof/roof planes of the property at issue. The proposal editing/generation module may include the following: PV product type, lease and/or utility inflation rate selection module 606; a solar electric system kit design optimizer 608 (a GUI portion of the optimization utility described herein); a results display 610 (which can be based on the various selections and information entered into the job editing and mapping modules); and a proposal completion module 614 that presents an optimum PV kit configuration. As previously described, one or more operations/features of the optimization utility may be re-run and/or re-iterated depending on the needs of a user at 612.

FIG. 9B illustrates various operations that can be performed in the above-described rules engine and calculation engine aspects of the optimization utility in accordance with various embodiments. These operations may be performed on the ‘back-end’ of the optimization utility, the entry and output of relevant data occurring via the GUI described above.

First, and in the process of job editing via the job editing module of FIG. 9A, a CPE function call can be performed at 616 to retrieve an electric rate list for use in conjunction data entry into electricity utility rate selection and energy consumption entry module 602.

Second, and with regard to the rules engines, an inverter type determination can be made at 618 during execution of the optimization utility.

Third, and as part of the calculation engine, proposal data can be retrieved at 620, along with energy-related statistical and financial data retrieval 622 (e.g., the aforementioned electric and financial projections retrieved via CPEFunction calls). Calculation of payments can be performed at 624 via the aforementioned ABCFunction calls for calculating, e.g., an initial down payment and yearly lease payments that can be included in the relevant data output to a user. Also as described above, the performance of these operations can be iteratively repeated per the iteration rules. Moreover, slope calculation at 626 for determined points/intervals and smallest slope determination at 628 can be performed. Additionally, proposal data can be retrieved (again) at 630 depending on the latest calculations, as is the case with energy-related statistical/financial data retrieval at 632, and payment calculation at 634. At 636, based on the goal-seeking process for determining a highest savings PV configuration described above, an optimal configuration for a solar electric system can be determined at 636. This and all other relevant/desired data can be output to the GUI via results display module 610.

It should be noted that one or more data repositories may be accessed in accordance with various embodiments for retrieval of relevant data in accordance with various embodiments. At least some of the relevant data that may be retrieved from such data repositories has been previously discussed with respect to FIGS. 3, 4, and 6. Moreover, calls to the CPEFunctions and ABCFunctions may also entail accessing and retrieving data from data repositories associated with those functions.

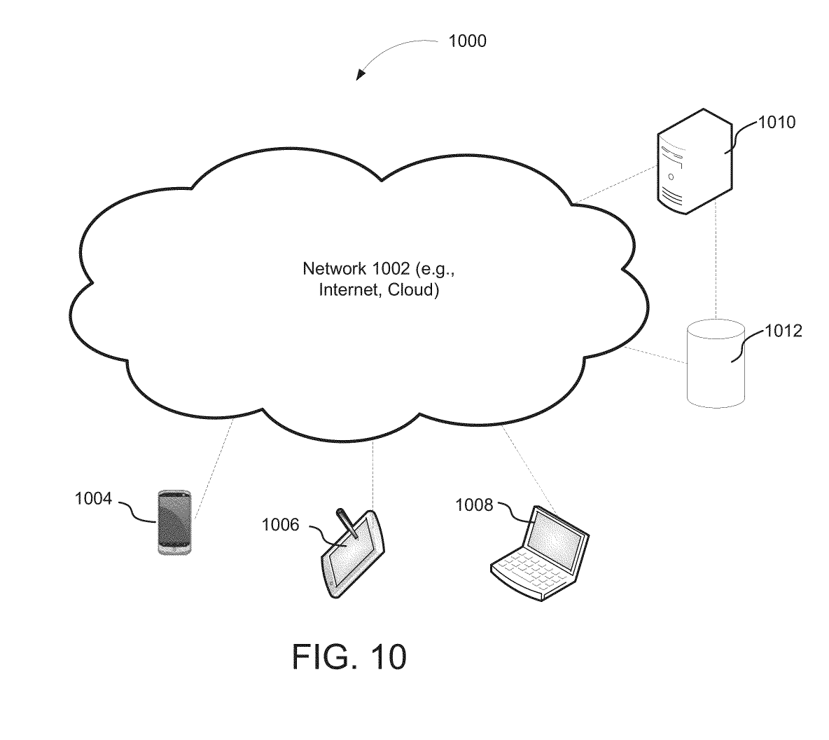

As described above, the optimization utility may be a standalone application that can be hosted on a web server and accessed via the Internet, or implemented as an executable application on a laptop PC, tablet PC, smart phone etc. The optimization utility may also be implemented as a mobile application that can be implemented on a mobile device including a front-end GUI. FIG. 10 illustrates an example communications system 1000 in accordance with various embodiments.

Accordingly various communication capabilities (via, e.g., one or more transceiver radios, communication modules, etc.), such as WiFi or other local area network (LAN) connectivity can be implemented for effectuating communications between a device hosting or on which the optimization utility is accessed and, e.g., data repositories, third-party services, etc. For example, a cloud-based or data network (e.g., Internet) system architecture may be utilized, which can include a network 1002 through which devices such as a smart phone 1004, tablet PC 1006, or laptop PC 1008 can communicate with a server that, e.g., hosts the optimization utility, a third-party web service, etc. Access to one or more data repositories 1012 may be also be effectuated via communications through network 1002. It should be noted that any appropriate device(s) and/or communication methods can be utilized in accordance with various embodiments, not limited to those described herein.

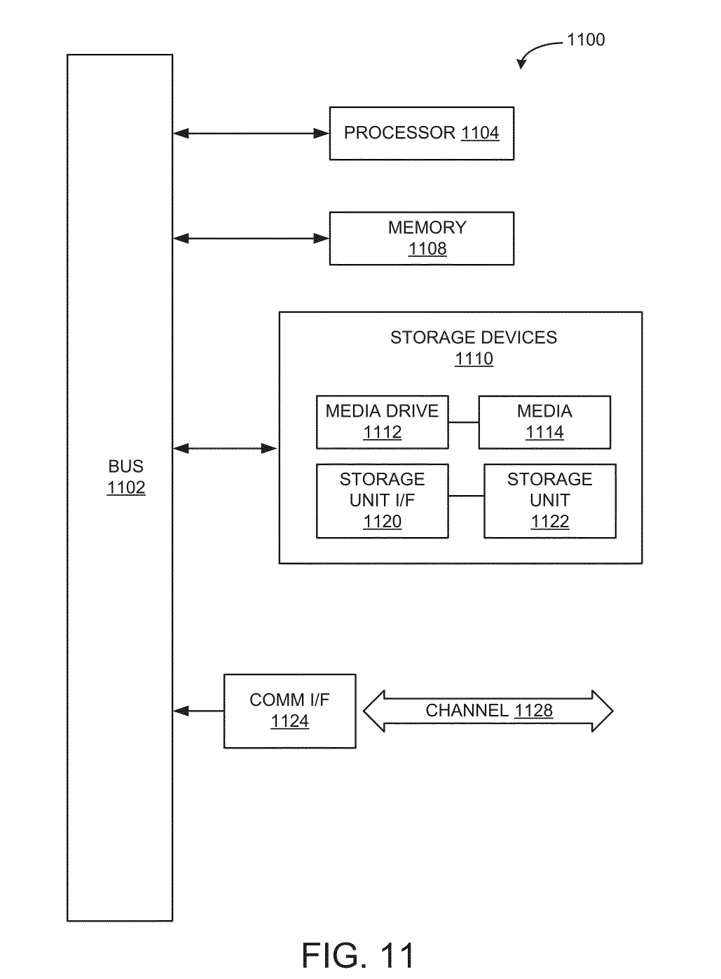

FIG. 11 illustrates an example computing module that may be used to implement the various features and/or functionality of the optimization utility disclosed herein.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 11. Various embodiments are described in terms of this example-computing module 1100. After reading this description, it will become apparent to a person skilled in the relevant art how to implement the application using other computing modules or architectures.

Referring now to FIG. 11, computing module 1100 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 1100 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1100 might include, for example, one or more processors, controllers, control modules, or other processing devices, such as a processor 1104. Processor 1104 might be implemented using a general-purpose or special-purpose processing engine such as, for example, a microprocessor, controller, or other control logic. In the illustrated example, processor 1104 is connected to a bus 1102, although any communication medium can be used to facilitate interaction with other components of computing module 1100 or to communicate externally.

Computing module 1100 might also include one or more memory modules, simply referred to herein as main memory 1108. For example, preferably random access memory (RAM) or other dynamic memory might be used for storing information and instructions to be executed by processor 1104. Main memory 1108 might also be used for storing temporary variables or other intermediate information during execution of instructions to be executed by processor 1104. Computing module 1100 might likewise include a read only memory (“ROM”) or other static storage device coupled to bus 1102 for storing static information and instructions for processor 1104.

The computing module 1100 might also include one or more various forms of information storage mechanism 1110, which might include, for example, a media drive 1112 and a storage unit interface 1120. The media drive 1112 might include a drive or other mechanism to support fixed or removable storage media 1114. For example, a hard disk drive, a floppy disk drive, a magnetic tape drive, an optical disk drive, a CD or DVD drive (R or RW), or other removable or fixed media drive might be provided. Accordingly, storage media 1114 might include, for example, a hard disk, a floppy disk, magnetic tape, cartridge, optical disk, a CD or DVD, or other fixed or removable medium that is read by, written to or accessed by media drive 1112. As these examples illustrate, the storage media 1114 can include a computer usable storage medium having stored therein computer software or data.

In alternative embodiments, information storage mechanism 1110 might include other similar instrumentalities for allowing computer programs or other instructions or data to be loaded into computing module 1100. Such instrumentalities might include, for example, a fixed or removable storage unit 1122 and an interface 1120. Examples of such storage units 1122 and interfaces 1120 can include a program cartridge and cartridge interface, a removable memory (for example, a flash memory or other removable memory module) and memory slot, a PCMCIA slot and card, and other fixed or removable storage units 1122 and interfaces 1120 that allow software and data to be transferred from the storage unit 1122 to computing module 1100.

Computing module 1100 might also include a communications interface 1124. Communications interface 1124 might be used to allow software and data to be transferred between computing module 1100 and external devices. Examples of communications interface 1124 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1124 might typically be carried on signals, which can be electronic, electromagnetic (which includes optical) or other signals capable of being exchanged by a given communications interface 1124. These signals might be provided to communications interface 1124 via a channel 1128. This channel 1128 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1108, storage unit 1120, media 1114, and channel 1128. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1100 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
determining a number of roof planes associated with a building structure to be implemented with a photovoltaic (PV) system;
depending on the number of roof planes, determining a type of PV system on which to base an optimization determination;
iteratively determining at least one PV kit combination for each PV product combination that produces the highest net savings for an owner of the building structure, the at least one PV kit combination making up the PV system, and wherein each PV product combination comprises at least one PV module and at least one of a string inverter and a micro inverter.

2. The method of claim 1, wherein the at least one PV module comprises one of a PV module brand and a PV module model, and wherein the iterative determination of the at least one PV kit combination comprises progressively narrowing down possible PV system configurations including both crystalline PV module and thin film PV module based PV system configurations.

3. The method of claim 1, further comprising determining if the number of roof planes is greater than one.

4. The method of claim 3, further comprising determining, upon a determination that the number of roof planes is greater than one, whether the azimuths of the roof planes are symmetrical.

5. The method of claim 4, further comprising considering, upon a determination that the number of roof planes is greater than one and that the azimuths of the roof planes are symmetrical, both a string inverter based PV system and a micro inverter based PV system as possible types of the PV system.

6. The method of claim 4, further comprising determining upon a determination that the number of roof planes is greater than one and that the azimuths of the roof planes are asymmetrical, whether the tilts of the roof planes are substantially the same.

7. The method of claim 6, further comprising considering, upon a determination that the number of roof planes is greater than one, that the azimuths of the roof planes are asymmetrical, and that the tilts of the roof planes are substantially the same, both a string inverter based PV system and a micro inverter based PV system as possible types of the PV system.

8. The method of claim 6, further comprising, upon a determination that the number of roof planes is greater than one, that the azimuths of the roof planes are asymmetrical, and that the tilts of the roof planes are not substantially the same, defaulting to a micro inverter based PV system.

9. The method of claim 3, further comprising determining, upon a determination that the number of roof planes is greater than one, whether the projected amount of shading on the roof planes is less than 20%.

10. The method of claim 9, further comprising, upon a determination that the number of roof planes is greater than one and that the projected amount of shading on the roof planes is less than 20%, defaulting to a string inverter based PV system.

11. The method of claim 9, further comprising, upon a determination that the number of roof planes is greater than one and that the projected amount of shading on the roof planes is greater than 20%, defaulting to a micro inverter based PV system.

12. The method of claim 1, further comprising, determining if a maximum number of PV modules on at least one of the roof planes is less than a number of PV modules in a smallest possible PV kit for a string inverter based PV system.

13. The method of claim 12, further comprising considering, upon a determination that the maximum number of PV modules on at the least one of the roof planes is less than the number of PV modules in the smallest possible PV kit for the string inverter based PV system, both a string inverter based PV system and a micro inverter based PV system as possible types of the PV system.

14. The method of claim 12, further comprising, upon a determination that the maximum number of PV modules on at the least one of the roof planes is less than the number of PV modules in the smallest possible PV kit for the string inverter based PV system, defaulting to a micro inverter based PV system.

15. A solar electrical system optimizer, comprising:
a memory configured to store instructions;
a processor, operatively coupled to the memory and configured to execute instructions, the instructions causing the processor to:
initiate proposal generation, the proposal generation including one or more recommendations for a photovoltaic (PV) system optimized with regard to highest net savings for an owner of the building structure;
determine a number of roof planes associated with a building structure to be implemented with the PV system;
depending on the number of roof planes, determine a type of the PV system on which to base an optimization determination; and
iteratively determine at least one PV kit combination for each PV product combination that produces the highest net savings for the owner of the building structure, the at least one PV kit combination making up the PV system, and wherein each PV product combination comprises at least one PV module and at least one of a string inverter and a micro inverter.

16. The method of claim 15, wherein the instructions causing the processor to iteratively determine the at least one PV kit combination for each PV product combination that produces the highest net savings for the owner of the building structure comprise instructions that further cause the processor to perform the iterative determination based on an initially determined default inverter type, the initially determined default inverter type comprising one of the string inverter and the micro inverter.

17. The method of claim 15, wherein the instructions causing the processor to iteratively determine the at least one PV kit combination for each PV product combination that produces the highest net savings for the owner of the building structure comprise instructions that further cause the processor to perform the iterative determination based on both the string inverter based PV product combination and the micro inverter based PV product combination.

18. The method of claim 15, wherein the instructions causing the processor to iteratively determine the at least one PV kit combination for each PV product combination that produces the highest net savings for the owner of the building structure comprise instructions that further cause the processor to perform the iterative determination based on both a crystalline PV module based PV product combination and a thin film PV module based PV product combination.

19. The method of claim 15, wherein the instructions further cause the processor to generate proposal and leasing documentation.

20. The method of claim 16, wherein the instructions further cause the processor to capture electronic signatures for the generated proposal and leasing documentation.
